(19) United States
(12) Patent Application Publication
(10) Pub. No.: US 2005/0000262 A1
(43) Pub. Date: Jan. 6, 2005

(54) Method for producing a metal sheet, metal sheet and device for structuring the surface of a metal sheet

(75) Inventors: Hans-Joachim Schreiber, Bretten (DE); Wolfgang Schneider, Eppingen (DE)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: BLANCO GmbH + Co KG, Oberderdingen (DE)

(21) Appl. No.: 10/749,811

(22) Filed: Dec. 30, 2003

Related U.S. Application Data
(63) Continuation of application No. PCT/EP02/06551, filed on Jun. 14, 2002.

(30) Foreign Application Priority Data
Jul. 4, 2001 (DE) 10134506.2

(51) Int. Cl. B32B 3/00

(52) U.S. Cl. 72/197; 428/687; 428/600

(57) ABSTRACT

The aim of the invention is to provide a method for producing a metal sheet, especially a steel sheet, at least one surface of which is provided with a surface structure that provides as structural elements depressions and/or elevations, and which metal sheet is substantially resistant to scratches and finger prints. According to the inventive method, the surface structure is configured as a random microstructure.

The present disclosure relates to the subject matter disclosed in PCT application No. PCT/EP02/06551 of Jun. 14, 2002, the entire specification of which is incorporated herein by reference.

The present invention relates to a method for producing a metal sheet, in particular a steel sheet, wherein at least one surface of the metal sheet is provided with a surface structure, which comprises structural elements in the form of depressions and/or elevations.

Such methods are known from the state of the art.

In particular, it is known to provide the surface of a metal sheet with a linen structure or leather graining in order to give the viewer the optical impression of a linen material or a leather material.

Furthermore, it is known to provide the surface of a metal sheet with a structure which comprises thin linear structural elements in order to give the optical impression of a brushed surface.

Finally, it is known to provide the surface of a steel sheet with a surface structure which is composed of regularly formed structural elements in a regular arrangement.

However, such a regular structuring of the surface of the steel sheet leads to a pronounced anisotropy in regard to the properties of this surface, especially the reflective properties, and with regard to the resistance to abrasion thereof in the event that it is subjected to abrasion whilst in use.

Such anisotropy can lead—in dependence on the orientation of a scratch with respect to the preferred directions of the surface—to increased susceptibility to scratching and—in dependence on the orientation of the preferred directions of the surface with respect to the incident light and with respect to the viewer—to increased visibility of finger prints.

Consequently, the object of the present invention is to provide a method for producing a metal sheet of the type mentioned hereinabove which will lead to a metal sheet having a very low susceptibility to scratching and one which renders finger prints less visible.

In accordance with the invention, this object is achieved, in the case of a method comprising the features mentioned in the preamble of claim 1, in that the surface structure is in the form of an unordered microstructure.

Herein, a microstructure is to be understood as being a surface structure which is substantially homogeneous on a length scale of 3 mm.

In particular, homogeneity of the surface structure on a length scale of 3 mm is present if the deviation of the level averaged over an arbitrary circular section of the surface having a diameter of 3 mm from the level averaged over the entire surface amounts to less than 10% of the maximum deviation of the level of the surface from the average level of the surface.

In practice, such a microstructure is no longer perceptible to the eye of a normal sighted viewer and, at an observation distance of approximately 50 cm, gives the impression of a homogeneous non-structured surface.

In contrast thereto, the known linen and leather-grained structuring of the surface of metal sheets may be regarded as macro-structures which, at an observation distance of 50 cm, are easily recognizable by the eye of a normal sighted viewer as a structuring of the surface and, as such, would readily be noticed.

In the case of the known linen or leather-grained structures, the structural elements of the surface structure have an average diameter of more than 1 mm.

In contrast thereto, provision is made in a preferred embodiment of the invention for the structural elements of the microstructure to have an average diameter of less than 0.5 mm, and preferably of less than 0.3 mm.

Furthermore, provision may be made for the extent of the structural elements in every direction aligned in parallel with the surface of the metal sheet to be smaller than 0.5 mm, and preferably smaller than 0.3 mm.

Furthermore, provision is preferably made for at least a part of the structural elements of the microstructure on the surface of the metal sheet to be in the form of elevations having a maximum height of less than approximately 0.1 mm.

Alternatively or in addition thereto, provision may be made for at least a part of the structural elements of the microstructure on the surface of the metal sheet to be in the form of depressions having a maximum depth of less than approximately 0.1 mm.

The method in accordance with the invention can be effected in a particularly simple manner if the microstructure is applied to the surface of the metal sheet by an embossing process, and in particular, by means of an embossing roller.

The disorder of the microstructure can be produced by an irregular sequence of differently formed structural elements, by an irregular distribution of the structural elements over the surface, by an irregular alignment of the structural elements with respect to a given longitudinal direction and/or by an irregular shape of the structural elements.

The susceptibility to scratching and the visibility of finger prints on the micro-structured surface of the metal sheet are reduced by the unordered construction of the microstructure produced in accordance with the invention, whilst the abrasion resistance in the event of use in abrasive conditions and the cleaning-friendliness are improved.

These advantages obtained in accordance with the invention are particularly evident if the microstructure has a periodic length in at least one longitudinal direction of the metal sheet which is greater than ten times, and is preferably greater than one hundred times, the average diameter of the structural elements of the microstructure.

The disorder of the microstructure can, for example, be produced when the microstructure comprises at least two types of structural elements which differ from one another in regard to their outlines, and if these different types of structural elements are distributed over the surface of the metal sheet in an irregular sequence.

Hereby, each of the structural elements may have a regularly formed outline, i.e. an outline having point and/or mirror symmetry.

However, the disorder of the microstructure can be increased still further in advantageous manner, if the microstructure comprises structural elements having irregularly formed outlines.

Furthermore, the disorder of the microstructure is preferably produced by distributing the structural elements of the microstructure over the surface of the metal sheet in an irregular manner.

In particular, provision may be made for the distances between the centre points of the outlines of mutually adjacent structural elements not to have fixed, discrete values, but rather, for there to be a spread in these distances.

In addition thereto, provision may be made for the angles, which the connecting lines interconnecting the centre points of the outlines of mutually adjacent structural elements include with a given longitudinal direction of the metal sheet, not to have fixed, discrete values, but rather, for there to be a spread in these angles.

Here, the centre point of the outline is to be understood as being the centre of gravity of the area of the surface bounded by the respective outline line of the pertinent structural component.

In a particularly preferred embodiment of the method in accordance with the invention, provision is made for the angles, which the connecting lines that interconnect the centre points of the outlines of mutually adjacent structural elements include with a given longitudinal direction of the metal sheet, to be distributed substantially uniformly over the angular range from 0° to 360°.

The disorder of the microstructure in accordance with the invention can be further increased by forming at least a part of the structural elements in non-rotationally symmetrical manner, and by arranging for the orientations of these structural elements relative to a given longitudinal direction of the metal sheet not to have fixed, discrete values, but rather, for there to be a spread in these orientations.

It is particularly advantageous, if the orientations of the non rotationally symmetrical structural elements with respect to the given longitudinal direction of the metal sheet are distributed substantially uniformly over the angular range from 0° to 360°.

In regard to the arrangement of the centre points of the outlines of the structural elements, it is to advantage if the centre points of the outlines of the structural elements form a pattern which has a periodic length in at least one longitudinal direction of the metal sheet that is greater than ten times, and preferably greater than one hundred times, the average diameter of the structural elements of the microstructure.

It is particularly expedient, if the microstructure is substantially isotropic, i.e. if it does not have a preferred direction.

In particular, such isotropy of the microstructure leads to a large proportion of the light incident on the surface of the metal sheet provided with the microstructure not being reflected directly, but rather, being reflected in a diffuse manner. This high proportion of diffuse reflection strengthens the impression of homogeneity for the viewer of the micro-structured surface of the metal sheet.

The method in accordance with the invention is particularly well suited to the production of high-grade steel sheets, and in particular, chrome-nickel steel sheets.

A further object of the present invention is to provide a metal sheet which has a very low susceptibility to scratching and for which the visibility of finger prints is very low.

This object is achieved by the metal sheet in accordance with claim 17.

The dependent claims 18 to 32 are concerned with special embodiments of the metal sheet in accordance with the invention whose advantages have already been expounded hereinabove in connection with the special embodiments of the method in accordance with the invention.

Claims 33 to 35 relate to a shaped part which has been formed from a metal sheet in accordance with the invention by one or more reshaping processes, for example, by embossing and/or deep-drawing.

Claim 36 relates to a device for structuring a surface of a metal sheet which comprises an embossing element, and in particular, an embossing roller whose surface is provided with a surface structure which comprises structural elements in the form of depressions and/or elevations, wherein the surface structure is in the form of an unordered microstructure.

This microstructure of the embossing element can be etched and/or engraved into the surface of the embossing element.

Furthermore, provision may be made for the surface of the embossing element to be provided with a wear-protection layer consisting, for example, of chrome, TiN and/or TiC in order to increase the durability of the embossing element.

Further features and advantages of the invention form the subject matter of the following description and the graphic illustration of exemplary embodiments.

In the drawings:

FIG. 1 shows a schematic illustration of a device for structuring the surface of a metal sheet;

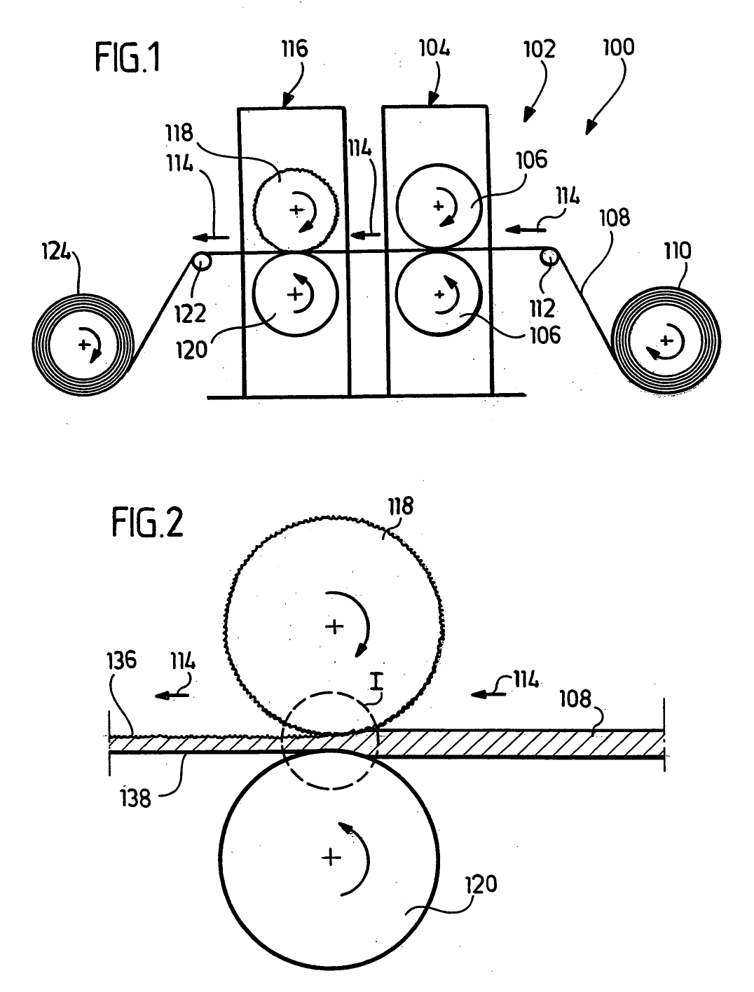

FIG. 2 an enlarged schematic illustration of an embossing roller and a counter-roller in the device depicted in FIG. 1;

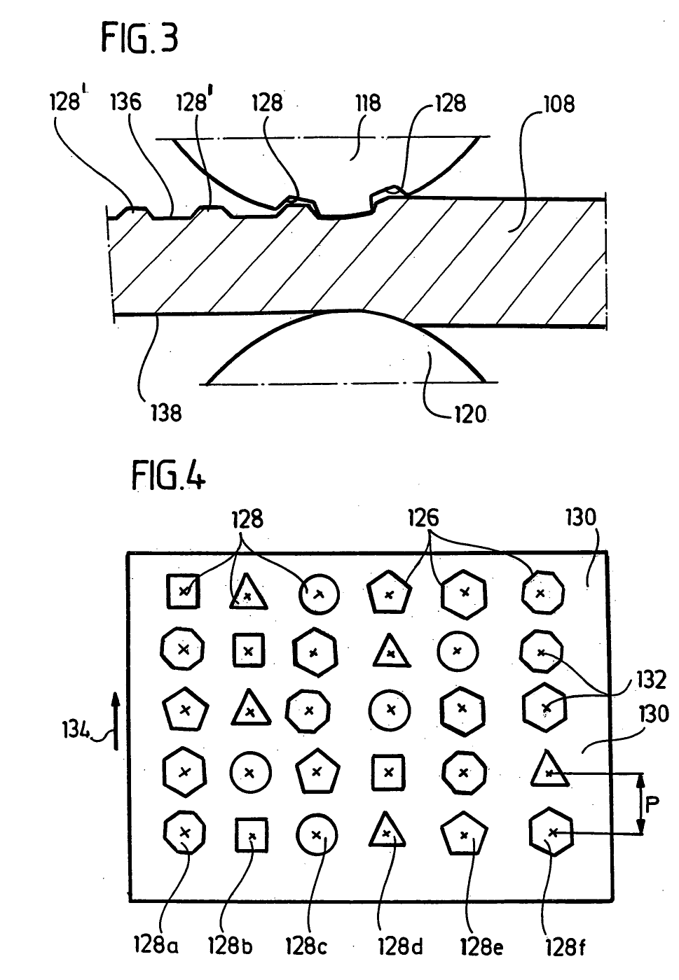

FIG. 3 an enlarged schematic illustration of the region I in FIG. 2;

FIG. 4 a schematic section of a microstructure which comprises structural elements that have different types of regular outlines although they are arranged in a regular manner;

FIG. 5 a schematic section of a microstructure which comprises structural elements that have mutually similar outlines although they are arranged in an irregular manner as regards their mutual spacings and angular positions;

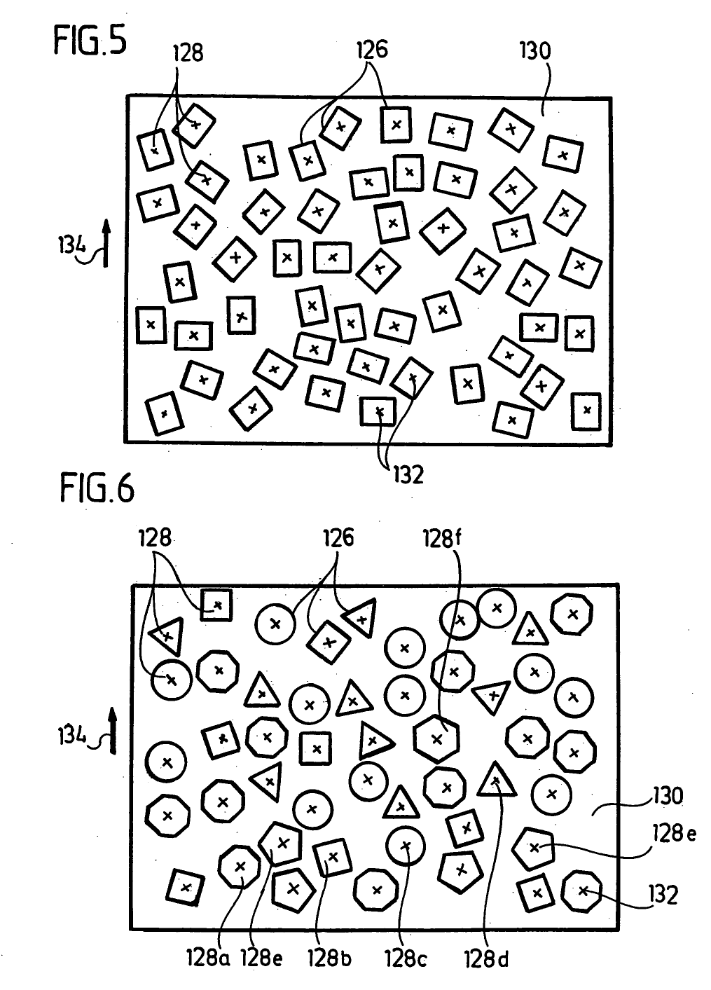

FIG. 6 a schematic section of a microstructure which comprises structural elements that have different types of regular outlines and are arranged in an irregular manner as regards their mutual spacings and angular positions;

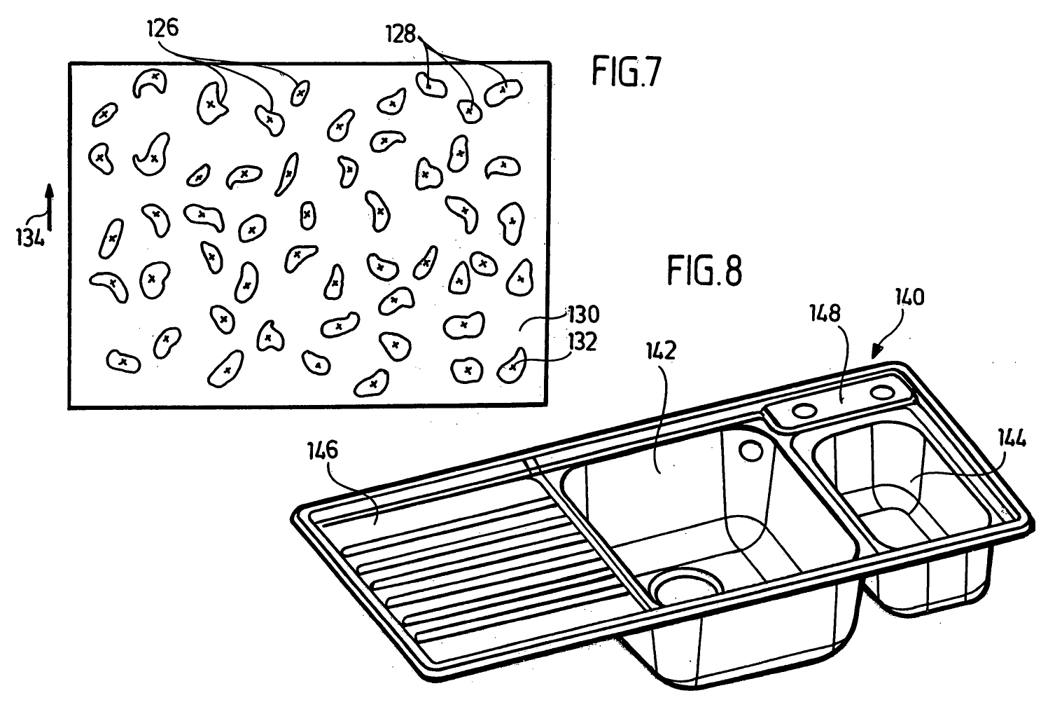

FIG. 7 a schematic section of a microstructure which comprises structural elements that have mutually different irregular outlines and are arranged in an irregular manner as regards their mutual spacings and angular positions; and

FIG. 8 a schematic perspective illustration of a sink top formed out of a metal sheet by a deep-drawing process.

Similar or functionally equivalent elements are designated by the same reference symbols in all of the Figures.

Steel sheets, and in particular, chromium-nickel steel sheets are manufactured by initially producing a hot-rolled strip from the melted steel alloy in a continuous casting plant, the hot-rolled strip then being annealed in one or more annealing lines and de-scaled in an etching line. A cold-rolling process follows the hot-rolled-strip annealing and etching processes.

The thus produced cold-rolled strip is subjected to further treatment in either open, heated, continuous annealing and etching lines, or, in bright-annealing plants. After the cold-rolled-strip annealing process, the steel strips are subjected to temper rolling on a skin-pass mill stand, on a so-called planetary rolling mill for example, in order to improve the flatness, the superficial fine structure and the gloss of the produced steel strip by virtue of this temper rolling process.

A section 102 of a device for manufacturing a steel sheet bearing the general reference 100 is illustrated in FIG. 1 and comprises a skin pass mill stand 104 having two skin pass rollers 106 which rotate in mutually opposite directions. The steel sheet 108 requiring treatment runs through the vertical gap between the two skin pass rollers 106, said sheet being pulled off a delivery roller 110, diverted by means of a guide roller 112 and then supplied in the running direction 114 to the skin pass rollers 106 of the skin pass mill stand 104.

Following the skin pass mill stand 104 in the running direction 114, there is an embossing machine 116 which comprises an embossing roller 118 whose peripheral surface is provided with a surface structure, and a counter-roller 118 whose peripheral surface is substantially smooth.

After the steel sheet has passed through the gap between the embossing roller 118 and the counter-roller 120 which rotate in mutually opposite directions, it is diverted by means of a guide roller 122 and wound up on a take-up roller 124.

The outer surface of the embossing roller 118 is provided with a surface structure which is in the form of an unordered microstructure.

Examples of such possible microstructures are illustrated in FIGS. 4 to 7 in sectional manner.

In each case hereby, only the lines 126 which bound a respective one of the structural elements 128 are illustrated in FIGS. 4 to 7; an illustration of the lthree-dimensional structure of the structural elements 128 has been dispensed with for reasons of clarity. If the structural elements 128 are in the form of depressions, then, commencing from the smooth surface 130 lying between the structural elements 128, these depressions extend into the plane of the drawing in FIGS. 4 to 7; by contrast, if the structural elements 128 are in the form of elevations, then, commencing from the substantially smooth surface 130, these elevations extend out of the plane of the drawing in FIGS. 4 to 7.

The microstructure illustrated in FIG. 4 comprises structural elements 128 wherein the centre points 132 of the outlines are arranged in a regular manner, namely at the grid points of a regular lattice, for example, a square lattice having a periodic length p.

Here, the centre point of an outline is to be understood as being the centroid of the surface area bounded by the respective outline line 126.

Despite the regular arrangement of the centre points 132 of the outlines, the microstructure illustrated in FIG. 4 is an unordered microstructure since the microstructure comprises a plurality, six for example, of different types 126a to 126f of structural elements which differ in regard to the outlines 126 thereof. The association of the different types of structural elements 128 with the grid points of the lattice underlying the arrangement of the centre points 132 of the outlines is effected in a random manner so that the microstructure is unordered due to this random distribution of the different types of structural elements 128 despite the regular arrangement of the centre points 132 of the outlines.

The periodic length of the microstructure in the direction 134 around the circumference of the embossing roller 118 preferably amounts to more than ten times the average distance between two mutually adjacent structural elements 128 and preferably more than ten times the average diameter of the structural elements 128.

In particular, provision may be made for the periodic length of the microstructure of the embossing roller 118 to be equal to the peripheral length of the embossing roller 118.

The individual structural elements 128 of the microstructure may have arbitrary geometrical forms and may, for example, be in the form of cones, truncated cones, pyramids, truncated pyramids, spherical segments, razor-cut outlines, prisms or the like.

The average diameter of the structural elements 128 preferably amounts to less than approximately 0.3 mm.

The maximum height of the structural elements 128 on the embossing roller 118 (in the case of elevations) or the maximum depth of the structural elements 128 in the embossing roller 118 (in the case of depressions) preferably amounts to less than approximately 0.5 mm.

In the case of the microstructure illustrated in FIG. 4, those structural elements 128 of the same type are, in each case, oriented in the same way relative to the circumferential direction 134 of the embossing roller 118; however, provision could also be made for the orientation of those structural elements 128, which are not rotationally symmetric, to vary with respect to the circumferential direction 134. In particular, the angular distribution of the orientations of the structural elements 128 with respect to the circumferential direction 134 could be a distribution which is substantially uniform over the angular range from 0° to 360°.

An alternative microstructure that is illustrated in FIG. 5 comprises structural elements 128 which each have the same outline 126. Nevertheless, the microstructure illustrated in FIG. 5 is unordered because the centre points 132 of the outlines of the structural elements 128 are distributed irregularly over the peripheral surface of the embossing roller 118 and because the outlines 126 of the structural elements 128 are aligned at irregularly varying angles relative to the circumferential direction 134 of the embossing roller 118. In particular, the angular distribution of the orientations of the outlines 126 of the structural elements 128 relative to the circumferential direction 134 may be in the form of a uniform distribution. In this case, the microstructure illustrated in FIG. 5 is an isotropic microstructure.

As can be seen from FIG. 5, there may be a spread in the distances between the centre points 132 of the outlines of mutually adjacent structural elements 128, and also a spread in the angular positions at which the centre points 132 of the outlines of mutually adjacent structural elements 128 are arranged relative to one another.

The alternative microstructure illustrated in FIG. 6 combines the disorder properties of the microstructures illustrated in FIGS. 4 and 5. Namely, the microstructure illustrated in FIG. 6 comprises a plurality, six for example, of different types of structural elements 128 which differ in regard to the outlines 126 thereof. In addition to the disorder caused by the different outlines 126, the centre points 132 of the outlines of the structural elements 128 are also distributed irregularly over the surface of the embossing roller 118 so that there is a spread in the distances between the centre points 132 of the outlines of mutually adjacent structural elements 128 and a spread in the relative angular positions of mutually adjacent structural elements 128.

Moreover, the non rotationally symmetric structural elements 128 point have a variable orientation relative to the circumferential direction 134 of the embossing roller 118.

In particular, the angular distribution of the orientations of the structural elements 128 relative to the circumferential direction 134 could be in the form of a uniform distribution over the angular range from 0° to 360°.

The microstructure illustrated in FIG. 6 is also isotropic.

In like manner to the microstructures illustrated in FIGS. 5 and 6, the alternative microstructure illustrated in FIG. 7 also has an irregular distribution of the centre points 132 of the outlines of the structural elements 128 over the peripheral surface of the embossing roller 118.

However, the microstructure illustrated in FIG. 7 is distinguished by virtue of the fact that the outlines 126 of the structural elements 128 are not formed in a regular manner, i.e. they exhibit neither point nor mirror symmetry. Rathermore, the outlines 126 of these structural elements 128 are irregularly formed.

Moreover, these irregularly formed outlines 126 are oriented in a random manner relative to the circumferential direction 134 of the embossing roller 118 so that the microstructure illustrated in FIG. 7 is also isotropic.

The microstructure pattern that is desired in each case is formed on the peripheral surface of the embossing roller 118 which, for example, consists of a steel material, by means of an etching technique or an engraving technique.

To this end, patterns, sketches, drawings or sets of data from which the desired microstructure is apparent are supplied to an engraving works. In the engraving works, the surface of the embossing roller is formed in such a way as to ensure the rapport, i.e. such that no break in the surface structure of the embossing roller is visible at the point whereat the two opposite edges of the given microstructure adjoin one another.

If the microstructure is to be formed on the embossing roller 118 by an etching technique, then a photosensitive layer is applied to the surface of the embossing roller 118 and this is exposed to light in accord with the predefined microstructure, preferably, with the help of a laser. The peripheral surface of the embossing roller 118 is then treated with an acid which removes the surface of the roller at the non-illuminated locations thereby resulting in the desired microstructure on the peripheral surface of the embossing roller 118.

If the desired microstructure is to be formed on the peripheral surface of the embossing roller 118 by an engraving technique, then the desired surface image is produced on the peripheral surface of the embossing roller 118 with the help of an engraving technique, for example, by means of a micro-grinding tool, a milling cutter or a chisel, whereby due consideration to the periodicity the embossing roller 118 is likewise given.

The embossing roller 118 may be provided with a wear-protection layer before and/or after the etching process or the engraving process with which the desired microstructure of the embossing roller 118 is produced.

Thus, for example, provision may be made for the peripheral surface of the embossing roller 118 to be hard chrome-plated.

As an alternative or in addition thereto, it is possible to form a wear-protection layer on the peripheral surface of the embossing roller 118 consisting, for example, of TiN or TiC, or to form this layer by means of a PVD method (Physical Vapour Deposition).

The diameter of the embossing roller 118 is preferably more than approximately 100 mm, and in particular, more than approximately 200 mm since, in the case of such a comparatively large diameter which exceeds the diameter of conventional skin pass rollers, a more precise three-dimensional structuring of the structural elements 128 of the microstructure on the peripheral surface of the embossing roller 118 is attainable.

In the course of its passage between the embossing roller 118 and the counter-roller 120, a microstructure complementary to that of the microstructure on the peripheral surface of the embossing roller 118 is rolled into the surface 136 of the steel sheet 108 facing the embossing roller 118.

Since the peripheral surface of the embossing roller 118 is in the form of a closed ring, the microstructure applied to the surface 136 of the steel sheet 108 has a periodic length which corresponds to the circumferential length of the embossing roller 118.

Moreover, the microstructure produced on the surface 136 of the steel sheet 108 corresponds to the microstructure of the peripheral surface of the embossing roller 118 that was described hereinabove with reference to FIGS. 4 to 7, whereby the structural elements 128′ in the form of elevations on the surface of the steel sheet 108 correspond to the structural elements 128 in the form of depressions on the embossing roller 118.

Contrariwise, the structural elements 128′ in the form of depressions on the surface of the steel sheet 108 correspond to the structural elements 128 in the form of elevations on the embossing roller 118.

A further difference between the microstructures on the embossing roller 118 on the one hand and those on the structured steel sheet 108 on the other is that the height of the elevations produced on the surface 136 of the steel sheet 108 is less than the depth of the depressions corresponding thereto on the embossing roller 118, and the depth of the depressions produced on the steel sheet 108 is less than the height of the elevations corresponding thereto on the embossing roller 118.

The amplitude of the microstructure produced on the surface 136 of the steel sheet 108 is determined by the contact pressure with which the embossing roller 118 and the counter-roller 120 are pressed towards one another and/or by the width of the gap between the peripheral surface of the embossing roller 118 on the one hand and the peripheral surface of the counter-roller 120 on the other.

The amplitude of the microstructure produced on the steel sheet 108 can thus be adjusted by adjusting the embossing depth produced by the embossing device 116 to a desired value.

Preferably, the height of the elevations produced on the steel sheet 108 or the depth of the depressions produced in the steel sheet 108 amounts to less than approximately 0.05 mm.

Since the peripheral surface of the counter-roller 120 in the embossing device 116 is not structured, the lower surface 138 of the steel sheet 108 remains substantially smooth even after the passage thereof through the embossing device 116.

The total thickness of the steel sheet 108 is reduced by less than 10% during the passage thereof through the embossing device 116.

After the desired microstructure has been rolled into the steel sheet in the embossing device 116, the steel sheet 108 may then be submitted to a further annealing process, a so-called recovery annealing process, in order to eliminate the work-hardening resulting from the embossing process and so as to virtually re-establish the deformation properties of the steel sheet 108 that existed prior to the embossing process.

The steel sheet 108 manufactured in the manner described hereinabove has a micro-structured surface 136 which appears to be homogeneous to a normal sighted viewer at a viewing distance of at least 50 cm.

This impression of a homogeneous surface is assisted by the fact that the microstructure embossed into the surface 136 of the steel sheet 108 leads to the light incident on this surface being reflected in a substantially fully diffused manner with only a small fraction thereof being directly reflected.

Due to the embossed microstructure, the surface 136 of the steel sheet 108 is less susceptible to scratching and finger prints are less visible, whilst there is increased abrasion resistance in abrasive conditions and increased cleaning friendliness.

Shaped parts, which immediately represent a finished end-product or else represent a part of a finished end-product that is combined with other shaped parts or other materials so as to produce the finished end product, can be produced in known manner from suitably formed sections of the thus manufactured steel sheet 108 using one or more forming techniques, for example, by embossing and/or deep-drawing.

Such an end product, which consists of one or more shaped parts of the steel sheet in accordance with the invention, can, for example, be a sink top 140 which is illustrated in FIG. 8 and comprises a sink 142, a leftovers bowl 144, a draining surface 146 and a mixer tap bank 148.

The sink top 140 can be produced from just a single sheet metal section of the steel sheet 108 manufactured in accordance with the invention by a shaping process wherein the steel sheet 108 is oriented in such a way that the surface 136 provided with the microstructure forms the visible side of the sink top 140 facing the user of the sink top 140.

As an alternative thereto, a sink top could also be produced from a plurality of such shaped parts which are welded to one another.

Furthermore for example, table tops, work tops or sink top accessories such as draining bowls or the outer coverings of mixer taps for example, or furniture or parts of furniture formed totally or partly of steel sheet can also be made by shaping the steel sheet 108 provided with the microstructure.

1. A method for producing a metal sheet, in particular a steel sheet, wherein at least one surface of the metal sheet is provided with a surface structure which comprises structural elements in the form of depressions and/or elevations, wherein the surface structure is in the form of an unordered microstructure.

2. A method in accordance with claim 1, wherein the structural elements of the microstructure have an average diameter of less than 0.5 mm, preferably of less than 0.3 mm.

3. A method in accordance with claim 1, wherein the structural elements of the microstructure on the surface of the metal sheet are in the form of elevations having a maximum height of less than approximately 0.1 mm.

4. A method in accordance with claim 1, wherein at least a part of the structural elements of the microstructure on the surface of the metal sheet are in the form of depressions having a maximum depth of less than approximately 0.1 mm.

5. A method in accordance with claim 1, wherein the microstructure is formed on the surface of the metal sheet by an embossing process, in particular, by means of an embossing roller.

6. A method in accordance with claim 1, wherein in at least one longitudinal direction of the metal sheet, the microstructure has a periodic length which is greater than ten times, and is preferably greater than one hundred times, the average diameter of the structural elements of the microstructure.

7. A method in accordance with claim 1, wherein the microstructure comprises at least two types of structural elements which differ from one another in regard to the outlines thereof.

8. A method in accordance with claim 1, wherein the microstructure comprises structural elements having irregularly formed outlines.

9. A method in accordance with claim 1, wherein the structural elements of the microstructure are distributed irregularly over the surface of the metal sheet.

10. A method in accordance with claim 9, wherein there is a spread in the distances between the centre points of the outlines of mutually adjacent structural elements.

11. A method in accordance with claim 1, wherein there is a spread in the angles which the connecting lines interconnecting the centre points of the outlines of mutually adjacent structural elements include with a given longitudinal direction of the metal sheet.

12. A method in accordance with claim 11, wherein the angles, which the connecting lines interconnecting the centre points of the outlines of mutually adjacent structural elements include with a given longitudinal direction of the metal sheet, are distributed substantially uniformly over the angular range from 0° to 360°.

13. A method in accordance with claim 1, wherein at least a part of the structural elements is not rotationally symmetrical, and in that there is a spread in the orientations of these structural elements relative to a given longitudinal direction of the metal sheet.

14. A method in accordance with claim 13, wherein the orientations of the non-rotationally symmetrical structural elements with respect to the given longitudinal direction of the metal sheet are distributed substantially uniformly over the angular range from 0° to 360°.

15. A method in accordance with claim 1, wherein the centre points of the outlines of the structural elements form a pattern which has a periodic length in at least one longitudinal direction of the metal sheet that is greater than ten times, and is preferably greater than one hundred times, the average diameter of the structural elements of the microstructure.

16. A method in accordance with claim 1, wherein the microstructure is substantially isotropic.

17. A metal sheet, and in particular a steel sheet, which is provided with a surface structure on at least one of the surfaces thereof, said surface structure comprising structural elements in the form of depressions and/or elevations, wherein the surface structure is in the form of an unordered microstructure.

18. A metal sheet in accordance with claim 17, wherein the structural elements of the microstructure have an average diameter of less than 0.5 mm, and preferably of less than 0.3 mm.

19. A metal sheet in accordance with claim 17, wherein at least a part of the structural elements of the microstructure on the surface of the steel sheet are in the form of elevations having a maximum height of less than approximately 0.1 mm.

20. A metal sheet in accordance with claim 17, wherein at least a part of the structural elements of the microstructure on the surface of the metal sheet are in the form of depressions having a maximum depth of less than approximately 0.1 mm.

21. A metal sheet in accordance with claim 17, wherein the microstructure was produced on the surface of the metal sheet by an embossing process, in particular, by means of an embossing roller.

22. A metal sheet in accordance with claim 17, wherein in at least one longitudinal direction of the metal sheet, the microstructure has a periodic length which is greater than ten times, and is preferably greater than one hundred times, the average diameter of the structural elements of the microstructure.

23. A metal sheet in accordance with claim 17, wherein the microstructure comprises at least two types of structural elements which differ from one another in regard to the outlines thereof.

24. A metal sheet in accordance with claim 17, wherein the microstructure comprises structural elements having irregularly formed outlines.

25. A metal sheet in accordance with claim 17, wherein the structural elements of the microstructure are distributed irregularly over the surface of the metal sheet.

26. A metal sheet in accordance with claim 25, wherein there is a spread in the distances between the centre points of the outlines of mutually adjacent structural elements.

27. A metal sheet in accordance with claim 17, wherein there is a spread in the angles which the connecting lines interconnecting the centre points of the outlines of mutually adjacent structural elements include with a given longitudinal direction of the metal sheet.

28. A metal sheet in accordance with claim 27, wherein the angles, which the connecting lines interconnecting the centre points of the outlines of mutually adjacent structural elements include with a given longitudinal direction of the metal sheet, are distributed substantially uniformly over the angular range from 0° to 360°.

29. A metal sheet in accordance with claim 17, wherein at least a part of the structural elements is not rotationally symmetric, and in that there is a spread in the orientations of these structural elements relative to a given longitudinal direction of the metal sheet.

30. A metal sheet in accordance with claim 29, wherein the orientations of the non-rotationally symmetrical structural elements with respect to the given longitudinal direction of the metal sheet are distributed substantially uniformly over the angular range from 0° to 360°.

31. A metal sheet in accordance with claim 17, wherein the centre points of the outlines of the structural elements form a pattern which has a periodic length in at least one longitudinal direction of the metal sheet that is greater than ten times, and is preferably greater than one hundred times, the average diameter of the structural elements of the microstructure.

32. A metal sheet in accordance with claim 17, wherein the microstructure is substantially isotropic.

33. A shaped part which is formed from a metal sheet in accordance with claim 17 by one or more reshaping processes, in particular, by an embossing and/or a deep-drawing process.

34. A shaped part in accordance with claim 33, wherein the shaped part forms a component of a sink top or a mixer tap.

35. A shaped part in accordance with claim 33, wherein the shaped part forms a component of a work top.

36. A device for structuring the surface of a metal sheet, comprising an embossing element, and in particular an embossing roller, whose surface is provided with a surface structure incorporating structural elements in the form of depressions and/or elevations, wherein the surface structure of the embossing element is in the form of an unordered microstructure.

37. A device in accordance with claim 36, wherein the microstructure is etched into the surface of the embossing element.

38. A device in accordance with claim 36, wherein the microstructure is engraved into the surface of the embossing element.

39. A device in accordance with claim 36, wherein the embossing element is provided with a wear-protection layer consisting of chrome, TiN and/or TiC for example.
